(19) United States
(12) Patent Application Publication
(10) Pub. No.: US 2015/0317912 A1
(43) Pub. Date: Nov. 5, 2015

(54) FOOTWEAR FOR TRAINING OR LEARNING HOW TO MARCH IN A GROUP

(71) Applicant: Christopher C. Wike, Austin, TX (US)

(72) Inventor: Christopher C. Wike, Austin, TX (US)

(21) Appl. No.: 14/471,027

(22) Filed: Aug. 28, 2014

Related U.S. Application Data
(63) Continuation-in-part of application No. 14/267,992, filed on May 2, 2014.

(51) Int. Cl. G09B 19/00; A43C 19/00

(52) U.S. Cl. CPC G09B 19/003; A43C 19/00

(57) ABSTRACT

Footwear that generates sound when an individual completes a proper marching step includes a toe strike plate disposed a toe step surface and a heel strike plate disposed a heel step surface. The strike plates produce an identifiable sound when they contact the ground during a marching step. The produced sound is used to improve marching technique and to synchronize marching steps. Methods of training and learning how to march in a group with the footwear are also described.

### CROSS-REFERENCE TO RELATED APPLICATIONS

This application claims the benefit of U.S. application Ser. No. 14/267,992, filed on May 2, 2014, the entirety of which is incorporated herein by reference.

### FIELD OF THE INVENTION

The present invention relates generally to marching groups, and more particularly, relating to footwear and a method to train members of a marching group to synchronize their steps or improve their marching technique.

### BACKGROUND OF THE INVENTION

Most people associate marching with marching bands and military parades, where members of the group step in a synchronized, steady, and rhythmic walk. Many marching groups, such as marching bands, not only perform in traditional style parades, but also perform competitive field shows. While marching, members of the group must maintain their alignment with other members in addition to marching with a uniform technique and time his or her steps and pace with the other members.

A roll step or glide step is a particular step style that is commonly used by marching bands to reduce unnecessary body movement that otherwise would negatively impact the visual appearance of the band's movement and musical instrument playing. The technical mechanics of performing a roll step are well known in the field, and thus only a basic description is necessary here. Essentially, a roll step is performed with a raised and slightly bent leg positioned such that the heel is slightly off the ground with the toes pointed upward. As the individual walks forward, the heel contacts the ground, and the individual “rolls” his or her foot to the ground from heel to toe. Roll stepping is difficult to master individually and is even more difficult to master stepping in synch with other members.

A crab step is another particular step style that is commonly used by marching bands when moving sideways to reduce unnecessary body movement that otherwise would negatively impact the visual appearance of the band's movement and musical instrument playing. The technical mechanics of performing a crab step are well known in the field, and thus only a basic description is necessary here. Essentially, a crab step is performed when the leading foot crosses over the opposing leg to the side, resulting in sideways movement while the torso and instrument remain facing the audience.

Varied techniques exist and are commonly used for marching backwards while the torso and instrument remain facing the audience in order to reduce unnecessary body movement that would negatively impact the visual appearance of the band's movement and musical instrument playing. The technical mechanics of backwards marching are well known in the field, with individual styles containing nuances that do not alter the basic motion, and thus only a basic description is necessary here. Essentially, backwards marching is performed by the individual stepping directly behind his or her current position with the point of impact being either the point of the toe or the ball of the foot. Depending on the style, the individual may either roll the foot from the toe to the heel or remain on the balls of the feet throughout the technique.

Marking time and step-offs are commonly used techniques for marching in place. The technical mechanics of marking time and step-offs are well known in the field, and thus only a basic description is necessary here. Marking time consists of the individual raising his or her heel or entire foot a short distance from the ground and returning it to the same location. Marking time is generally used to increase marching precision and increase musical timing while performing. Marking time may also include a rehearsal technique known as a step-off in which the individual will mark time while rehearsing and then take the first one or two steps when a new marching formation begins in the music. The foot is then returned to its original position.

Heretofore, there has been no development in the field that allow members of a marching group to train to march in synchronization by listening to sound produced by one's own steps relative to the sound produced by the steps of other members. Accordingly, there exists a need, including a method, device, or both to create a distinct sound while marching for the purpose of training members of a marching group to synchronize their steps and/or hone their marching technique.

### SUMMARY OF THE INVENTION

In accordance with the present invention, an apparatus and method for members of a marching group to train to step in synchronization and/or hone marching technique by listening to the sound produced by one's own steps relative to the sound produced by the steps of other members is provided.

In general, in one aspect, footwear for training members of a marching group to synchronize their steps and/or hone their marching technique is provided. The footwear includes a toe portion having a toe step surface, a heel portion connected to the toe portion and having a heel step surface, a toe strike plate disposed on the toe step surface, and a heel strike plate disposed on the heel step surface. The toe strike plate and the heel strike plate can be removably attached to the toe portion and the heel portion.

In general, in another aspect, a method for training a marching group to synchronize their steps is provided. The method includes the steps of:
a). one or more members of the marching group donning footwear including a toe portion having a toe step surface, a heel portion having a heel step surface, a toe strike plate disposed on the toe step surface, and a heel strike plate disposed on the heel step surface;
b). instructing the one or more members to perform a sequence of marching steps; and
c). instructing the one or more members to adjust his or her marching steps to produce sound from at least one of the toe strike plate and the heel strike plate in synch with the sound produced from at least one of the toe strike plate and the heel strike plate of another member of the marching group.

In general, in another aspect, a method for learning to march in a group is provided. The method including the steps of:
a). attaching a toe strike plate to a toe portion of the footwear of one or more members of the marching group to dispose the toe strike plate on a toe step surface of the footwear;
b). attaching a heel strike plate to a heel portion of the footwear of one or more members of the marching group to dispose the heel strike plate on a heel step surface of the footwear;
c). instructing the one or more members to perform a sequence of marching steps; and
d). instructing the one or more members to adjust his or her marching steps to produce sound from at least one of the toe strike plate and the heel strike plate in synch with the sound produced from at least one of the toe strike plate and the heel strike plate of another member of the marching group.

In general, in another aspect, a method for learning to march in a group is provided. The method including the steps of:
a). attaching a strike plate to one or both of a toe step portion and a heel step portion of one's footwear such that said strike plate is disposed on one or both of a toe step surface and a heel step surface;
b). performing a sequence of marching steps; and
c). adjusting one's marching steps to produce sound from said strike plate in synch with sound produced from a strike plate of another member of the marching group.

There has thus been outlined, rather broadly, the more important features of the invention in order that the detailed description thereof that follows may be better understood and in order that the present contribution to the art may be better appreciated.

Numerous objects, features, and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

For a better understanding of the invention, its operating advantages, and the specific objects attained by its uses, reference should be made to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 is an illustrative, front perspective view an article of footwear for training members of a marching group to synchronize their steps and/or hone their marching technique that is constructed in accordance with the principles of an embodiment of the present invention;

FIG. 2 is an illustrative, side elevation view of the footwear of FIG. 1;

FIG. 3 is an illustrative, rear perspective view of the footwear of FIG. 1; and

FIG. 4 is a cross-sectional view taken along line 4-4 in FIG. 3, illustrating a coupling between a strike plate and the footwear of FIG. 1 in accordance with an embodiment of the invention.

### DETAILED DESCRIPTION OF THE INVENTION

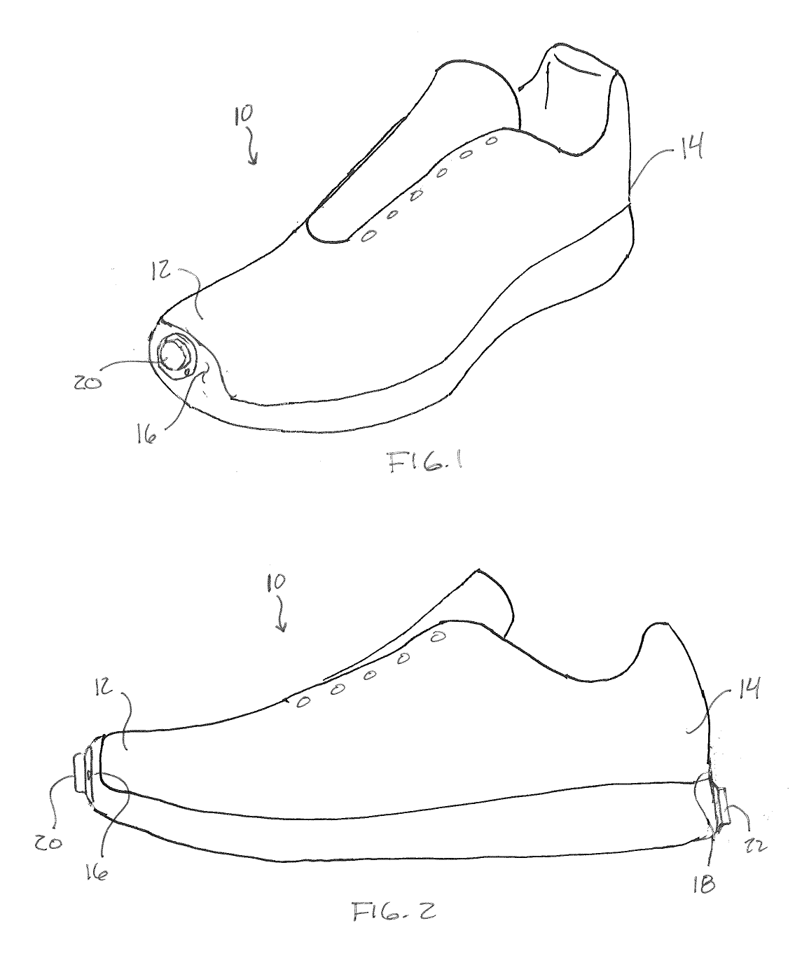

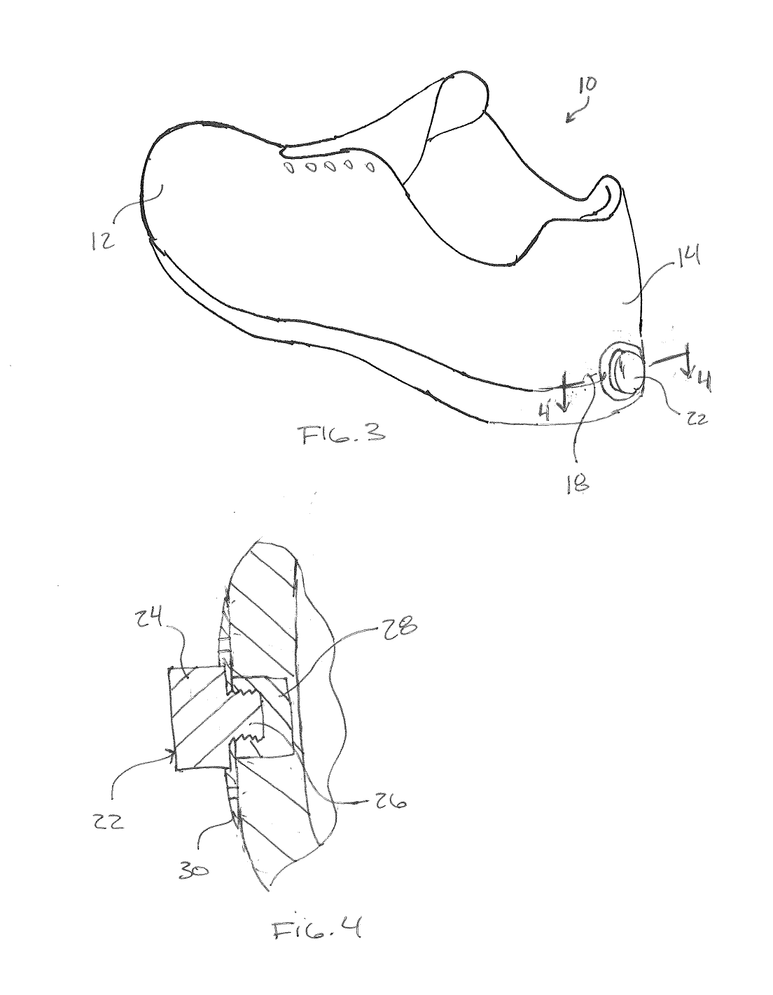

With reference to FIGS. 1 through 4, there is representatively illustrated footwear 10 that is constructed in accordance with an embodiment of the present invention. Footwear 10 is for use in connection with a method of training members of a marching group to synchronize their steps and/or hone their marching technique. It is to be understood that the terms step(s) and marching step(s), as used herein, includes roll stepping, crab stepping, marking time, step-offs, and the like maneuvers whether performed in place or not.

Footwear 10 is intended to be worn by members of a marching group and operates to generate an identifiable sound while stepping so that members are able to adjust their steps to produce the sound in synch with the sound produced from the steps of other members of the marching group.

Footwear 10, representatively illustrated as a low-top shoe, includes a toe portion 12 and a heel portion 14. The toe portion 12 includes a toe step surface 16 and the heel portion 14 includes a heel step surface 18. The toe step surface 16 is located at a position that is forward of the ball of the individual's foot and is generally vertically oriented relative to the sole of the footwear. Similarly, the heel step surface 18 is located at a position that is rearward of the heel of the individual's foot and is generally vertically oriented relative to the sole of the footwear.

A toe strike plate 20 is attached to the toe portion 12 so that it is attached, located or otherwise disposed on the toe step surface 16. A heel strike plate 22 is attached to the heel portion 14 so that it is attached, located or otherwise disposed on the heel step surface 18. Importantly, the toe strike plate 20 is positioned such that it is located forward of the ball of an individual's foot and the heel strike plate 22 is positioned rearward of the heel of an individual's foot. To this end, the toe strike plate 20 and the heel strike plate 22 are positioned such that the strike plates each create a recognizable sound at the impact point of a marching step, but remain set-off from the weight-bearing portions of the foot.

Further, the toe strike plate 20 and the heel strike plate 22 are positioned such that sound is produced or created from only the toe strike plate or the heel strike plate when a single marching step or maneuver is performed correctly. Thus, if an individual causes both the toe strike plate 20 and the heel strike plate 22 to create a sound during a single marching step or maneuver, the individual, hearing these sounds, knows the single marching step or maneuver was performed incorrectly.

Similarly, if during a single marching step or maneuver, an individual does not cause either of the toe strike plate 20 nor the heel strike plate 22 to create a sound, the individual will know that he or she incorrectly performed the marching step or maneuver.

In the illustrated embodiment, the toe strike plate 20 and the heel strike plate 22 are removably attached to the toe portion 12 and heel portion 14, respectively. This permits a user to attach the toe strike plate 20 and the heel strike plate 22 to the footwear 10 for practicing and then remove them when performing.

With particular reference to FIG. 4, there is illustrated a cross-section of the heel strike plate 22 attached to the heel portion 14, showing a detachable connection between the heel strike plate and the heel portion. In this exemplary configuration, the heel strike plate 22 and the heel portion 14 are structured and connected together in a manner similar to how a removable turf cleat is detachably connected to the sole of an article of footwear, such as a golf shoe, for example.

Particularly, the heel strike plate 22 includes a surface contact portion 24 which is configured to make contact with the ground surface during a marching step to generate the identifiable sound. The heel strike plate 22 further includes a threaded shaft 26 that is screwed into a cooperating threaded boss 28 recessed in the heel portion 14. The surface contact portion 24 can be made of various materials and one skilled in the art is capable of selecting a material or combination of materials to achieve a desired sound or noise made by the strike plates.

The heel strike plate 22 also includes a collar 30 that is engageable with a tool (not shown) to attach or remove the strike plate 22, again similar to a removable turf cleat. The toe strike plate 20 is configured similarly to the heel strike plate 22 and separate discussion is not required for one of ordinary skill in the art to understand the construction of the toe strike plate. Additionally, the toe strike plate 20 and the heel strike plate 22 are representatively illustrated in the figures of the drawings and should not be limited to the particular shapes and configuration that are shown.

Other embodiments are also possible and the footwear 10 should not be limited to the illustrated configuration of the toe strike plate 20 and heel strike plate 22. For example, the toe strike plate 20 and the toe portion 12 could be configured to have other cooperable structures that permit the toe strike plate to be removably attached to the footwear. Of course the heel strike plate 22 and the heel portion 14 could be similarly configured. For example, the strike plates may be configured to be removably received by a socket or recess formed on the toe portion or heel portion of the footwear.

Consequently, in either embodiment, positioning the toe strike plate 20 and the heel strike 22 off of the load bearing surfaces (e.g., the ball and heel) of an individual's foot is an important distinction from a conventional tap shoe, which positions the taps over the foot's load bearing surfaces. Further, it is important to note and understand that a conventional tap shoe would not perform as desired because a tap shoe would create two sounds for each marching step, whether the step was performed correctly or incorrectly. Whereas, the footwear of the present invention is intended to produce sound from only one strike plate for each marching step when that marching step is performed correctly, and could produce sound from both strike plates or no sound from either strike plates when that marching step is performed incorrectly.

In use, it can now be understood, that an individual attaches one or both of the toe strike plate 20 and heel strike plate 22 to footwear 10. Then, as the individual practices a particular marching step, such as a roll step or backwards marching step, the toe strike plate 20 or heel strike plate 22 attached to the footwear will make a recognizable sound as they contact the ground when the individual executes a proper marching step. The user will listen to the sound produced from the respective strike plates to practice completing a proper step.

Further, in a group setting, such as the members of a marching band training together, each member will be able to listen to the sound from his or her own steps relative to the sound made from at least one other member's steps as the marching band practices. Hearing the sound from one's own steps relative to the sound of at least one other's steps permits the members to better coordinate their stepping and achieve synchronization.

In a particular method, a method for training a marching group is provided. The method includes one or more members of the marching group donning footwear including a toe portion having a toe step surface, a heel portion having a heel step surface, a toe strike plate disposed on the toe step surface, and a heel strike plate disposed on the heel step surface. Then instructing the one or more members to perform a sequence of marching steps and instructing the one or more members to adjust his or her marching steps to produce sound from at least one of the toe strike plate and the heel strike plate in synch with the sound produced from at least one of the toe strike plate and the heel strike plate of another member of the marching group.

The method can include the one or more members adjusting his or her marching steps to produce sound from only one of the toe strike plate and the heel strike plate while performing a marching step. The method can include the device being attached to only footwear of a left foot or right foot of the one or more members.

In another method, a method for learning to march in a group is provided. The method including attaching a toe strike plate to a toe portion of the footwear of one or more members of the marching group to dispose the toe strike plate on a toe step surface of the footwear. The method also includes attaching a heel strike plate to a heel portion of the footwear of one or more members of the marching group to dispose the heel strike plate on a heel step surface of the footwear. The method then includes instructing the one or more members to perform a sequence of marching steps and instructing the one or more members to adjust his or her marching steps to produce sound from at least one of the toe strike plate and the heel strike plate in synch with the sound produced from at least one of the toe strike plate and the heel strike plate of another member of the marching group.

A number of embodiments of the present invention have been described. Nevertheless, it will be understood that various modifications may be made without departing from the spirit and scope of the invention. Accordingly, other embodiments are within the scope of the following claims.

What is claimed is:

1. A method for training a marching group, the method comprising:
one or more members of the marching group donning footwear including a toe portion having a toe step surface, a heel portion having a heel step surface, a toe strike plate disposed on said toe step surface, and a heel strike plate disposed on said heel step surface;
instructing the one or more members to perform a sequence of marching steps; and
instructing the one or more members to adjust his or her marching steps to produce sound from at least one of said toe strike plate and said heel strike plate in synch with the sound produced from at least one of said toe strike plate and said heel strike plate of another member of the marching group.

2. The method of claim 1, wherein said instructing step includes said one or more members adjusting his or her marching steps to produce sound from only one of said toe strike plate and said heel strike plate while performing a marching step.

3. The method of claim 1, wherein said donning step includes said footwear being worn only on a left foot of said one or more members.

4. The method of claim 1, wherein said donning step includes said footwear being worn only on a right foot of said one or more members.

5. The method of claim 1, wherein said donning step further comprises said toe strike plate being removably attached to said toe portion and said heel strike plate being removably attached to said heel portion.

6. A method for training a marching group, the method comprising:
attaching a toe strike plate to a toe portion of the footwear of one or more members of the marching group to dispose said toe strike plate on a toe step surface of said footwear;
attaching a heel strike plate to a heel portion of said footwear of one or more members of the marching group to dispose said heel strike plate on a heel step surface of said footwear;
instructing the one or more members to perform a sequence of marching steps; and
instructing the one or more members to adjust his or her marching steps to produce sound from at least one of said toe strike plate and said heel strike plate in synch with the sound produced from at least one of said toe strike plate and said heel strike plate of another member of the marching group.

7. The method of claim 6, wherein said adjusting step includes producing sound from only one of said toe strike plate and said heel strike plate while performing a marching step.

8. The method of claim 6, wherein said attaching a toe strike plate includes attaching said toe strike plate to only footwear of a left foot.

9. The method of claim 6, wherein said attaching a toe strike plate includes attaching said toe strike plate to only footwear of a right foot.

10. The method of claim 6, wherein said attaching a heel strike plate includes attaching said heel strike plate to only footwear of a left foot.

11. The method of claim 6, wherein said attaching a heel strike plate includes attaching said heel strike plate to only a footwear of a right foot.

12. A method for learning to march in a group, the method comprising:
attaching a strike plate to one or both of a toe step portion and a heel step portion of one's footwear such that said strike plate is disposed on one or both of a toe step surface and a heel step surface;
performing a sequence of marching steps; and
adjusting one's marching steps to produce sound from said strike plate in synch with sound produced from a strike plate of another member of the marching group.

13. The method of claim 12, wherein said attaching step said footwear is only footwear of one's right foot.

14. The method of claim 12, wherein said attaching step said footwear is only footwear of one's left foot.
